(19) United States
(12) Patent Application Publication
(10) Pub. No.: US 2018/0180162 A1
(43) Pub. Date: Jun. 28, 2018

(54) POWER SYSTEM

(71) Applicant: HONDA MOTOR CO., LTD., Tokyo (JP)

(72) Inventors: Noriyasu HAKUTA, Saitama (JP); Kenta KOMADA, Tochigi (JP)

(73) Assignee: HONDA MOTOR CO., LTD., Tokyo (JP)

(21) Appl. No.: 15/834,319

(22) Filed: Dec. 7, 2017

(30) Foreign Application Priority Data
Dec. 22, 2016 (JP) 2016-249812

(51) Int. Cl. F16H 57/04; F16H 57/08; B60K 17/16; B60K 1/00

(52) U.S. Cl. CPC F16H 57/0404; F16H 57/08; F16H 57/0457; B60K 2001/001; B60K 17/165; B60K 1/00; F16H 57/045

(57) ABSTRACT

A power system includes: a rotating body; a housing which accommodates the rotating body; and a storage portion which is provided at a bottom of the housing to store a liquid medium. A part of the rotating body is located in the storage portion. A part of a strainer which is attachable to and detachable from the housing from outside protrudes in an area on a downstream side from an uppermost portion of the rotating body in a rotation direction of the rotating body, in an inner surface of the housing.

### CROSS-REFERENCE TO RELATED APPLICATION(S)

This application claims priority from Japanese Patent Application No. 2016-249812 filed on Dec. 22, 2016, the entire contents of which are incorporated herein by reference.

### FIELD

The present invention relates to a power system that is provided in an electric motor vehicle.

### BACKGROUND

There is known a power system that includes a rotating body, a housing for accommodating the rotating body, and a storage portion provided at a bottom of the housing to store lubricating oil. A part of the rotating body is located in the storage portion, and the lubricating oil stored in the storage portion is splashed with rotation of the rotating body and is supplied to a necessary portion in the housing.

In such a power system, when foreign matter such as metallic powder is mixed into lubricating oil, the foreign matter intrudes into a bearing or the like, resulting in causing an abnormal noise. In this regard, it is proposed that a strainer is disposed to remove foreign matter in the housing (for example, refer to JP-A-2003-014093 and JP-U-H01-025310).

However, in JP-A-2003-014093, since the lubricating oil is introduced to the strainer on the upstream side from the uppermost portion of the rotating body in the rotation direction of the rotating body, it is not possible to filter the lubricating oil flowing down along the inner surface of the housing and it is necessary to provide a special structure for recovering the lubricating oil, whereby there is room for improvement.

In JP-U-H01-025310, since the entire strainer is located inside the housing, it is difficult to access the strainer from the outside of the housing and the volume of the housing is increased.

### SUMMARY

The invention is to provide a power system in which attaching and detaching are easily performed and a liquid medium splashed by a rotating body can be efficiently filtered.

The invention provides following aspects (1) to (5).

(1) A power system (e.g., a power system 1 in an embodiment) including:

a rotating body (e.g., a second gear 52 in an embodiment);

a housing (e.g., a housing 4 in an embodiment) which accommodates the rotating body; and

a storage portion (e.g., a storage portion 44 in an embodiment) which is provided at a bottom of the housing to store a liquid medium, wherein

a part of the rotating body is located in the storage portion, and

a part of a strainer (e.g., a strainer 70 in an embodiment) which is attachable to and detachable from the housing from outside protrudes in an area on a downstream side from an uppermost portion of the rotating body in a rotation direction of the rotating body, in an inner surface of the housing.

(2) The power system according to (1), wherein

a protruding portion of the strainer includes an inflow portion (e.g., an inflow portion 71a in an embodiment) provided on an upper surface thereof and a discharge portion (e.g., a discharge portion 71b in an embodiment) provided on a side surface except a lower surface thereof.

(3) The power system according to (2), wherein

a guiding portion (e.g., a guiding portion 71c in an embodiment) is provided inside the strainer to guide the liquid medium toward a direction away from the discharge portion under the inflow portion, and

a filter (e.g., a filter 72) is provided between the inflow portion and the guiding portion.

(4) The power system according to any one of (1) to (3), wherein

the power system is a vehicle power system, and

the rotation direction is a rotation direction of the rotating body when the vehicle moves forward.

(5) The power system according to any one of (1) to (4), wherein

the power system includes:

an electric motor (e.g., an electric motor 2 in an embodiment) that drives a left wheel and a right wheel of the vehicle;

a transmission (e.g., a transmission 5 in an embodiment) that is disposed on power transmission paths between the electric motor and the left wheel and between the electric motor and the right wheel;

a differential gear system (e.g., a differential gear system 6 in an embodiment) that distributes output power shifted by the transmission to the left wheel and the right wheel,

the housing accommodates the electric motor, the transmission, and the differential gear system,

the transmission includes:

a first gear (e.g., a first gear 51 in an embodiment) that is mechanically connected to the electric motor;

a second gear (e.g., a second gear 52 in an embodiment) that has a rotation axis in common with the first gear and is mechanically connected to a differential gear casing (e.g., a differential gear casing 61 in an embodiment) of the differential gear system; and

a pinion gear (e.g., a pinion gear 53 in an embodiment) that meshes with the first gear and the second gear, and

the rotating body is the second gear.

According to aspect (1), since the strainer is disposed in the area on the downstream side from the uppermost portion of the rotating body in the rotation direction of the rotating body in the inner surface of the housing, it is possible to make the liquid medium splashed by the rotating body flow into the strainer and filtered with good efficiency, in the middle of flowing down along the inner surface of the housing.

In addition, the strainer is attachable to and detachable from the housing from outside, whereby maintenance of the strainer is facilitated.

Further, since only a part of the strainer protrudes inside the housing, it is possible to prevent the size of the housing from increasing.

According to aspect 2, in the protruding portion of the strainer, the inflow portion is provided on the upper surface thereof, and the discharge portion is provided on the side surface except the lower surface thereof. Therefore, it is possible to make the liquid medium flowed in from the inflow portion stay inside the strainer, thereby filtering a larger amount of liquid medium with good efficiency.

In addition, since the discharge portion is provided on the side surface except the lower surface, even when the rotating body rotates reversely, it is possible to prevent the liquid medium from flowing in the strainer from the discharge portion.

According to aspect 3, the guiding portion is provided inside the strainer to guide the liquid medium toward the direction away from the discharge portion under the inflow portion, and the filter is provided between the inflow portion and the guiding portion. Therefore, it is possible to filter the liquid medium with a wider area of the filter.

According to aspect 4, it is possible to filter a larger amount of liquid medium at the time of forward movement, which frequently occurs, of the vehicle by using the strainer.

According to aspect 5, it is possible to filter the liquid medium splashed by the second gear by using the strainer.

### BRIEF DESCRIPTION OF DRAWINGS

FIG. 1 is a sectional view of a power system according to an embodiment of the invention, and a sectional view taken along line A-A in FIG. 2.

FIG. 2 is a side view of a partition wall and a pinion gear inside the power system when viewed from a differential gear system side.

FIG. 3 is a perspective view of the pinion gear, a second gear, and a pinion holder (bearing is not illustrated) when viewed from the differential gear system side.

FIG. 4 is a sectional view taken along line B-B in FIG. 3.

FIG. 5 is a perspective view of a main part of the pinion holder when viewed from the pinion gear side.

FIG. 6 is a partial sectional view of the power system illustrated in FIG. 1, and is a sectional view taken along line C-C in FIG. 2.

FIG. 7 is a schematic view illustrating a position of a strainer with respect to a housing and the second gear.

FIG. 8 is a plan view of the strainer.

FIG. 9 is a sectional view taken along line D-D in FIG. 8.

### DETAILED DESCRIPTION

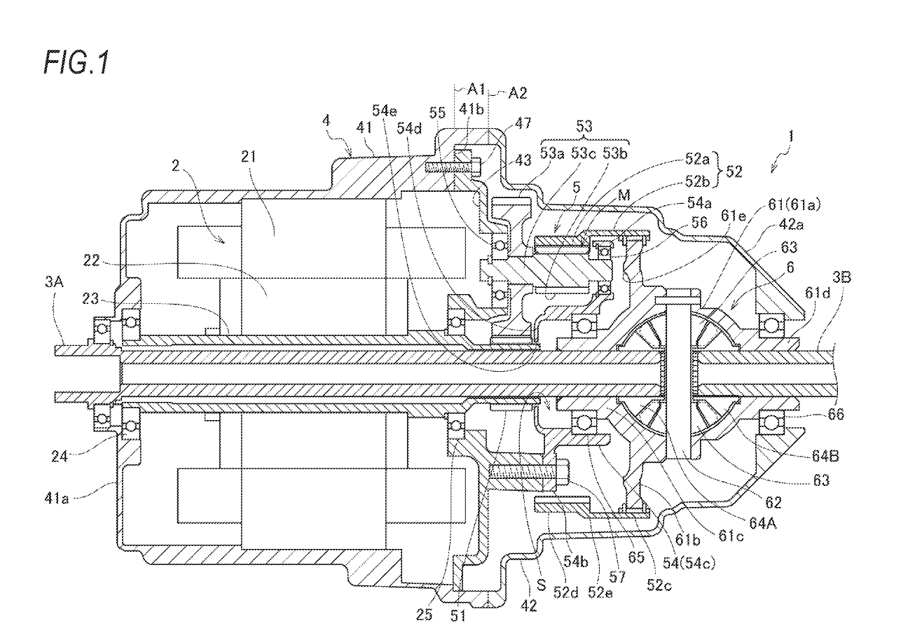

A power system 1 according to an embodiment of the invention will be described with reference to FIGS. 1 to 9.

The power system 1 of the embodiment includes an electric motor 2 that is a drive source for driving axles, and is provided in an electric motor vehicle such as a hybrid vehicle or an electric vehicle as a front wheel drive system or a rear wheel drive system.

### [Power System]

In FIG. 1, reference numerals 3A and 3B indicate left and right axles, which are coaxially disposed in a vehicle width direction. In the power system 1, a housing 4 has the entire shape formed into a substantially cylindrical shape, and includes therein the electric motor 2 for driving the axles, a transmission 5 that decelerates driving rotation of the electric motor 2, and a differential gear system 6 that distributes the driving rotation decelerated by the transmission 5 to the axles 3A and 3B.

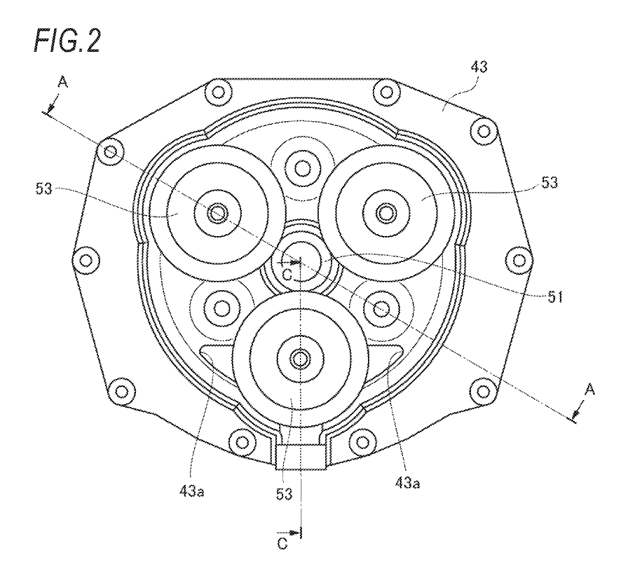

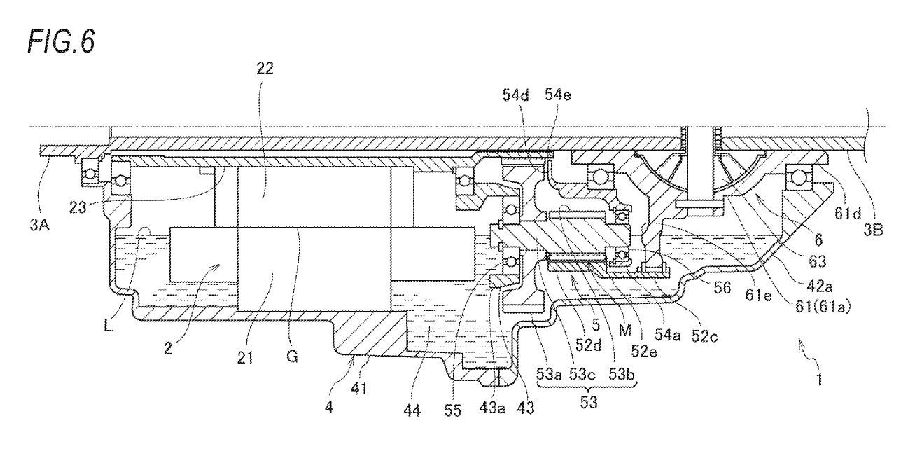

The housing 4 includes a first casing 41 for accommodating the electric motor 2 and a second casing 42 for accommodating the transmission 5 and the differential gear system 6. A partition wall 43 is provided at a boundary between the first casing 41 and the second casing 42, and an internal space of the first casing 41 is partitioned from an internal space of the second casing 42 by the partition wall 43. The partition wall 43 is fastened to a step portion 41b provided on an outer peripheral part of the first casing 41 with a bolt 47. Therefore, a mating surface A1 of the first casing 41 and the partition wall 43 is located closer to the first casing 41 relative to a mating surface A2 of the first casing 41 and the second casing 42. A bottom of the housing 4 functions as a storage portion 44 for storing lubricating oil (liquid medium), and the lubricating oil is stored up to a stationary oil level L illustrated in FIG. 6. The stationary oil level L is set lower than an air gap G of the electric motor 2 (a clearance secured between an inner periphery of a stator 21 and an outer periphery of a rotor 22 to be described below) so as to reduce an agitation loss of the lubricating oil in the electric motor 2. As also illustrated in FIG. 2, a communication port 43a is formed in a lower part of the partition wall 43 to allow the lubricating oil to flow therethrough.

### [Electric Motor]

The electric motor 2 includes the stator 21 fixed to an inner peripheral part of the first casing 41 and the rotor 22 disposed rotatably on the inner periphery of the stator 21. A rotor shaft 23 is coupled to an inner peripheral part of the rotor 22 so as to surround an outer periphery of one axle 3A, and the rotor shaft 23 is supported on an end wall 41a of the first casing 41 and the partition wall 43 through bearings 24 and 25 so as to be relatively rotable coaxially with the axle 3A. In addition, one end of the axle 3A and the rotor shaft 23 penetrates the partition wall 43 and extends into the second casing 42, and the other end of the axle 3A penetrates the end wall 41a of the first casing 41 and extends to the outside of the housing 4.

### [Transmission]

The transmission 5 includes a first gear 51 mechanically connected to the electric motor 2, a second gear 52 having the same rotation axis as that of the first gear 51 and mechanically connected to a differential gear casing 61 of the differential gear system 6, a plurality of pinion gears 53 meshing with the first gear 51 and the second gear 52, and a pinion holder 54 for supporting the plurality of pinion gears 53 to be rotatable and not to revolve, and the decelerated driving rotation is output to the differential gear casing 61 of the differential gear system 6 through the pinion gear 53 and the second gear 52 when the driving rotation of the electric motor 2 is input from the first gear 51.

The first gear 51 is an external gear, and is formed integrally with the rotor shaft 23. The pinion gear 53 includes a large diameter gear 53a which is an external gear, a small diameter gear 53b which is an external gear, and a pinion shaft 53c which supports the large diameter gear 53a and the small diameter gear 53b in an integrally rotatable manner. The large diameter gear 53a is coupled to the pinion shaft 53c on a side of the electric motor 2, and meshes with the first gear 51. In addition, the small diameter gear 53b is formed integrally with the pinion shaft 53c on a side of the differential gear system 6, and meshes with the second gear 52. An end of the pinion shaft 53c on the side of the electric motor 2 is rotatably supported on the partition wall 43 through the bearing 55, and an end thereof on the side of the differential gear system 6 is rotatably supported on a pinion gear supporting portion 54a of the pinion holder 54 through the bearing 56.

As illustrated in FIG. 2, the transmission 5 of the embodiment includes three pinion gears 53. The three pinion gears 53 are disposed at equal intervals (intervals of 120°) in a circumferential direction around the first gear 51. At least one of the three pinion gears 53 is partially or entirely located in the storage portion 44 described above, and functions as a rotating body that splashes the lubricating oil stored in the storage portion 44 with the rotation caused by the driving of the electric motor 2. In the example illustrated in FIG. 2, the lowermost pinion gear 53 disposed immediately below the first gear 51 functions as a rotating body for splashing the lubricating oil, and thus the splashed lubricating oil is supplied to two upper pinion gears 53. Here, assuming that the pinion gear 53 rotates in the counterclockwise direction in FIG. 2, the lubricating oil splashed by the rotation of the lowermost pinion gear 53 is mainly supplied to the pinion gear located at an upper left, and then the lubricating oil scattered by the rotation of the pinion gear located at the upper left is mainly further supplied to the pinion gear located at an upper right.

In the second gear 52, a gear portion 52a is an internal gear and meshes with the small diameter gear 53b of the pinion gear 53. The second gear 52 includes a connecting portion 52b extending from the gear portion 52a toward the differential gear system 6 across the outer peripheral side of the pinion holder 54 (pinion gear supporting portion 54a), and the connecting portion 52b is mechanically connected to the differential gear casing 61 of the differential gear system 6 through a connecting unit such as a spline. In other words, the second gear 52 includes a second-gear large diameter portion 52c constituting the connecting portion 52b with the differential gear casing 61, a second-gear small diameter portion 52d constituting the gear portion 52a meshing with the pinion gear 53, and a second gear connecting portion 52e for connecting the second-gear large diameter portion 52c and the second-gear small diameter portion 52d, and an outer diameter of the second-gear small diameter portion 52d is smaller than that of the second-gear large diameter portion 52c. Further, the second gear 52 has a lower end located in the storage portion 44 described above, and also functions as a rotating body for splashing the lubricating oil stored in the storage portion 44 with the rotation caused by the driving of the electric motor 2.

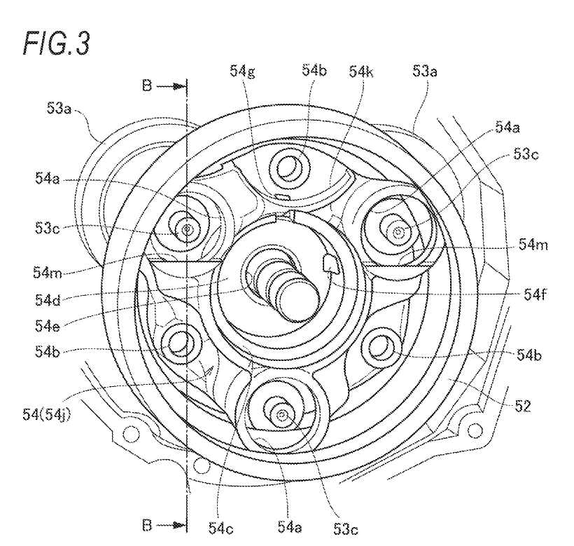

As illustrated in FIGS. 3 to 5, the pinion holder 54 includes three pinion gear supporting portions 54a each of which rotatably supports the pinion shaft 53c of the pinion gear 53 through the bearing 56, three fixed portions 54b that are fixed to the partition wall 43, and a bottomed cylindrical cup portion 54c formed on a center (on an inner diameter side of the pinion gear supporting portion 54a and the fixed portion 54b) of the pinion holder 54.

The pinion gear supporting portion 54a is disposed on the side of the differential gear casing 61 of the differential gear system 6 relative to a meshing portion M between the second gear 52 mechanically connected to the differential gear casing 61 of the differential gear system 6 and the small diameter gear 53b of the pinion gear 53. Thus, the other end of the pinion shaft 53c, in which one end thereof is supported by the partition wall 43 through the bearing 55, is supported by the pinion gear supporting portion 54a through the bearing 56, and thus the pinion gear 53 can be appropriately supported in a state of being held at both sides.

The three fixed portions 54b are located at intermediate portions between the pinion gear supporting portions 54a adjacent to each other in the circumferential direction, and are fastened to the partition wall 43 with bolts 57, respectively. Thereby, the partition wall 43 serves as a support member of the pinion holder 54 as well as a support member of the pinion shaft 53c.

The cup portion 54c surrounds the outer periphery of one axle 3A through the space portion S from one end side to the other end side of the meshing portion M in the axial direction and on the inner peripheral side of the meshing portion M in the radial direction, and the bottom 54d on one end side is provided with a through-hole 54e through which the axle 3A penetrates. In addition, the inner peripheral part on the other end side of the cup portion 54c rotatably supports one end side of the differential gear casing 61 through the bearing 65. Thereby, the pinion holder 54 serves as a support member of the differential gear casing 61 as well as a support member of the pinion gear 53.

### [Differential Gear System]

The differential gear system 6 includes the differential gear casing 61, a differential pinion shaft 62, a differential pinion gear 63, and left and right side gears 64A and 64B so as to allow difference in rotation of the left and right axles 3A and 3B while distributing the driving rotation, which is input to the differential gear casing 61 from the second gear 52, to the left and right axles 3A and 3B.

The differential gear casing 61 includes a spherical differential gear casing body 61a that accommodates the differential pinion shaft 62, the differential pinion gear 63, and the left and right side gears 64A and 64B, an input plate 61b that extends in the radial direction from the outer periphery of the differential gear casing body 61a and is mechanically connected to the second gear 52, and left and right extension portions 61c and 61d that extend in the axial direction from both sides of the differential gear casing body 61a. One extension portion 61c rotatably supports the one axle 3A at an inner peripheral part thereof, and an outer peripheral part thereof is rotatably supported by the pinion holder 54 through the bearing 65. Further, the other extension portion 61d rotatably supports the other axle 3B at an inner peripheral part thereof, and an outer peripheral part thereof is rotatably supported by the end wall 42a of the second casing 42 through the bearing 66.

The differential pinion shaft 62 is supported by the differential gear casing body 61a so as to be directed in a direction orthogonal to the axles 3A and 3B, and rotatably supports two differential pinion gears 63, which are bevel gears, inside the differential gear casing body 61a. That is, the differential pinion shaft 62 allows the differential pinion gears 63 to rotate while revolving with the rotation of the differential gear casing 61.

The left and right side gears 64A and 64B are bevel gears, are rotatably supported inside the differential gear casing body 61a so as to mesh with the differential pinion gears 63 from both sides, and are mechanically connected to the left and right axels 3A and 3B through the connecting unit such as the spline. In a state where the differential pinion gears 63 revolve without rotating, for example, during straight running, the left and right side gears 64A and 64B rotate at a constant speed, and the driving rotation is transmitted to the left and right axles 3A and 3B. Furthermore, during curve running or left or right turning, the differential pinion gears 63 rotate, so that the left and right side gears 64A and 64B rotate relative to each other and the difference in rotation between the left and right axles 3A and 3B is allowed.

### [Lubrication Function of Pinion Holder]

Next, a lubrication function of the pinion holder 54 will be described.

The pinion holder 54 has a storage space to store lubricating oil splashed from the storage portion 44 of the housing 4 by the second gear 52 or the pinion gear 53. The storage space is the above-described space portion S formed by the cup portion 54c and the one axle 3A, and the lubricating oil splashed by the second gear 52 or the pinion gear 53 flows into the space portion S through communication holes 54f and 54g (which will be described below) communicating with the space portion S.

The lubricating oil flowing into the space portion S is supplied to the above-described bearing 65 which is disposed adjacent to the space portion S for rotatably supporting one end side of the differential gear casing 61, whereby the bearing 65 is properly lubricated. In addition, the lubricating oil is also distributed from the space portion S to the inside of the differential gear system 6 requiring lubrication and the electric motor 2 that needs to be cooled by the lubricating oil. More specifically, the lubricating oil is supplied from the space portion S through the clearance between the axle 3A and the extension portion 61c of the differential gear casing 61 to the inside of the differential gear system 6, and is supplied from the space portion S to the electric motor 2 through the clearance between the axle 3A and the rotor shaft 23.

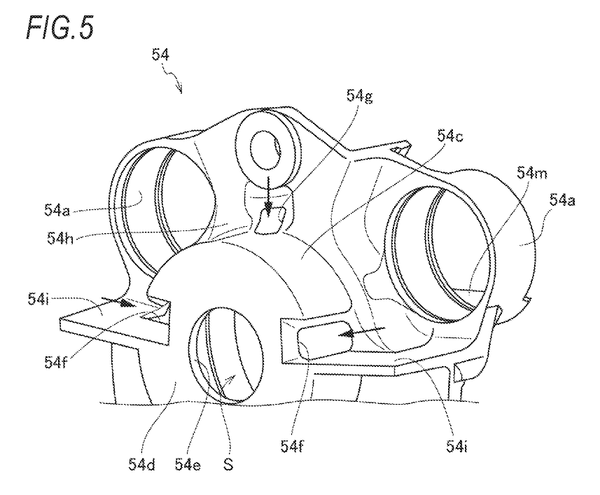

As illustrated in FIG. 5, the pinion holder 54 includes first guide portions 54i for receiving the lubricating oil, which is splashed by the second gear 52 or the pinion gear 53, on a first face 54h opposed to the pinion gear 53. The first guide portions 54i are protrusions that are formed on both sides of the cup portion 54c and extend linearly toward the cup portion 54c, and guide the received lubricating oil to the cup portion 54c. The communication hole 54f is formed in a connecting portion between the first guide portion 54i and the cup portion 54c, so that the lubricating oil received by the first guide portion 54i is stored in the space portion S through the communication hole 54f.

As illustrated in FIG. 3, the pinion holder 54 includes a second guide portion 54k for receiving the lubricating oil, which is splashed by the second gear 52 or the pinion gear 53, on a second face 54j opposed to the differential gear casing 61 of the differential gear system 6. The second guide portion 54k is a protrusion that is formed above the cup portion 54c and extends in an arc shape below the uppermost fixed portion 54b, and guides the received lubricating oil to the cup portion 54c. The communication hole 54g is formed in a connecting portion between the second guide portion 54k and the cup portion 54c, so that the lubricating oil received by the second guide portion 54k is stored in the space portion S through the communication hole 54g. The communication hole 54g also communicates with the first face 54h of the pinion holder 54.

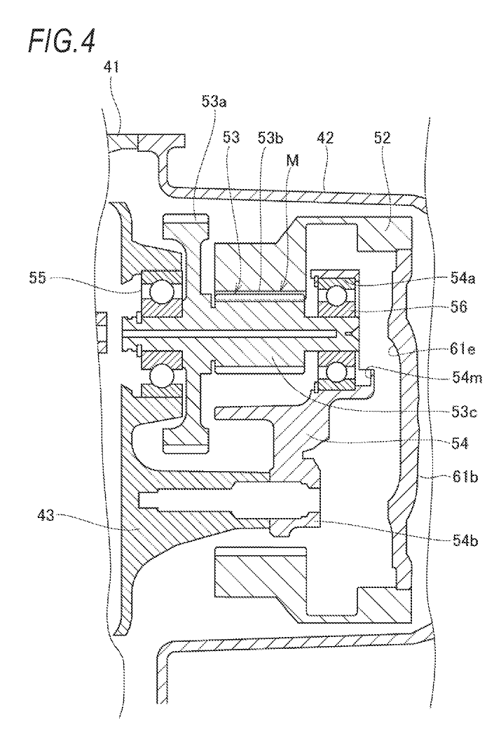

As illustrated in FIGS. 3 and 4, among the pinion gear supporting portions 54a of the pinion holder 54, the pinion gear supporting portions 54a supporting the two upper pinion gears 53 respectively include pockets 54m that store the lubricating oil at an opening end on the side of the second face 54j opposed to the differential gear casing 61 of the differential gear system 6. The pocket 54m temporality holds the lubricating oil supplied to the pinion gear supporting portion 54a, thereby enabling proper lubrication of the bearing 56.

By the way, some of the lubricating oil supplied from the space portion S to the bearing 65 flows to the outer periphery of the differential gear casing 61 by passing through the bearing 65, and receives a centrifugal force caused by the rotation of the differential gear casing 61 and moves radially outward along the input plate 61b. The input plate 61b of the embodiment includes a third guide portion 61e that guides the lubricating oil moving radially outward along the input plate 61b to the two upper pinion gear supporting portions 54a. The third guide portion 61e is an edge of an annular recess formed on a surface of the input plate 61b opposed to the pinion gear 53, and the lubricating oil moving radially outward along the input plate 61b is guided to the pinion gear supporting portion 54a by the edge formed in a position opposed to the pinion gear supporting portion 54a in the radial direction. Some of the lubricating oil splashed by the second gear 52 also flows in the same manner.

### [Strainer]

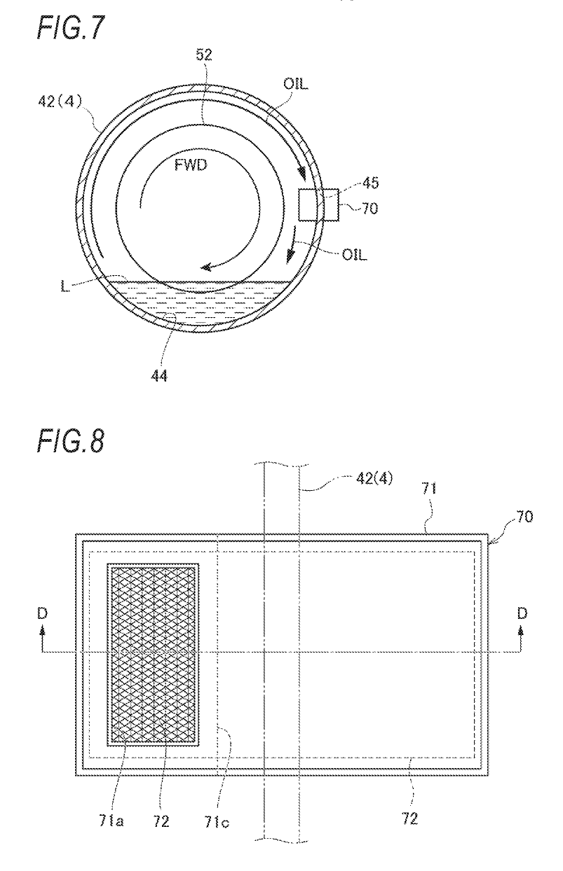

Next, a strainer 70 for filtering the lubricating oil in the housing 4 will be described with reference to FIGS. 7 to 9.

The rotation direction indicated by an arrow (FWD) in FIG. 7 is a rotation direction of the second gear 52 at the time of forward movement of the vehicle when viewed from the side of the differential gear system 6. In addition, reference numeral OIL is given to the lubricating oil splashed by the rotation of the second gear 52 in FIGS. 7 to 9.

As illustrated in FIGS. 7 to 9, the power system 1 includes a strainer 70 for filtering the lubricating oil in the housing 4. The strainer 70 includes a box-shaped casing 71 having an inflow portion 71a and a discharge portion 71b, and a filter 72 which filters the lubricating oil flowed from the inflow portion 71a into the casing 71 to remove foreign matter.

The strainer 70 is detachably mounted to a strainer attachment port 45 formed in the housing 4 from the outside. As illustrated in FIG. 7, a part of the strainer 70, which is mounted in the housing 4, protrudes to the inside of the housing 4, and the other part thereof protrudes to the outside of the housing 4. Accordingly, it is possible not only to secure the necessary volume for the strainer 70 while lowering the occupancy rate of the strainer 70 in the housing 4, but also to easily attach/detach the strainer 70 from the outside.

The strainer 70 protrudes in an area in the inner surface of the housing 4 facing the outer periphery surface of the second gear 52, and on a downstream side from the uppermost portion of the second gear 52 in the rotation direction of the second gear 52 at the time of forward movement of the vehicle. Accordingly, the lubricating oil splashed by the second gear 52 flows along the inner surface of the housing 4, and flows into the strainer 70 in the middle of returning to the storage portion 44.

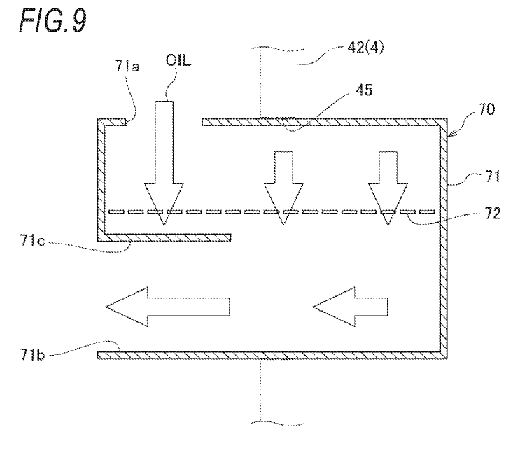

The inflow portion 71a and the discharge portion 71b are formed in a region, which protrudes into the housing 4, of the casing 71. The inflow portion 71a is formed on the upper surface of the casing 71, and makes the lubricating oil splashed by the second gear 52 flow into the strainer 70 in the middle of flowing along the inner surface of the housing 4. In addition, the discharge portion 71b is formed on the side surface of the casing 71 except the lower surface. As illustrated in FIG. 9, in this embodiment, the discharge portion 71b is formed on the front end surface in the protruding direction of the casing 71, that is, a surface facing the outer periphery surface of the second gear 52. Therefore, it is possible to make the lubricating oil flowed in from the inflow portion 71a stay inside the strainer 70, and even when the second gear 52 rotates reversely, it is also possible to prevent the lubricating oil from flowing into the strainer 70 from the discharge portion 71b.

The filter 72 has substantially the same planer shape as the inside of the casing 71, and is disposed between the inflow portion 71a and the discharge portion 71b, thereby filtering the lubricating oil flowed in from the inflow portion 71a to remove foreign matter.

Inside the casing 71, the guiding portion 71c is provided to guide the lubricating oil toward a direction away from the discharge portion 71b under the inflow portion 71a. The filter 72 is disposed between the inflow portion 71a and the guiding portion 71c, and the lubricating oil flowed in from the inflow portion 71a is filtered by the filter 72 while being guided toward the direction away from the discharge portion 71b by the guiding portion 71c. Accordingly, it is possible to filter the lubricating oil with a wider area of the filter 72.

As described above, according to the embodiment, the strainer 70 is disposed in the area on the downstream side from the uppermost portion of the second gear 52 in the rotation direction of the second gear 52 at the time of forward movement of the vehicle, in the inner surface of the housing 4. Therefore, the lubricating oil splashed by the second gear 52 is flowed in the strainer 70 in the middle of flowing along the inner surface of the housing 4, and it is possible to filter the lubricating oil with good efficiency.

In addition, the strainer 70 is attachable to and detachable from the housing 4 from the outside, so that maintenance of the strainer 70 is facilitated.

Since only the part of the strainer 70 protrudes into the housing 4, it is possible to prevent the housing 4 from increasing in size.

In the protruding portion of the strainer 70, the inflow portion 71a is provided on the upper surface, and the discharge portion 71b is provided on the side surface except the lower surface. Therefore, it is possible to make the lubricating oil flowed in from the inflow portion 71a stay inside the strainer 70, thereby filtering a larger amount of lubricating oil with good efficiency.

Since the discharge portion 71b is provided on the side surface except the lower surface, even when the second gear 52 rotates reversely, it is possible to prevent the lubricating oil from flowing from the discharge portion 71b into the strainer 70.

Further, the guiding portion 71c is provided inside the strainer 70 to guide the lubricating oil toward the direction away from the discharge portion 71b under the inflow portion 71a, and the filter 72 is provided between the inflow portion 71a and the guiding portion 71c. Therefore, it is possible to filter the lubricating oil with a wider area of the filter 72.

Since the strainer 70 is disposed in the area on the downstream side from the uppermost portion of the second gear 52 in the rotation direction of the second gear 52 at the time of forward movement of the vehicle, it is possible to filter a larger amount of lubricating oil using the strainer 70 at the time of forward movement which frequently occurs compared to the rearward movement.

It is noted that the invention is not limited to the above-described embodiment, but can be appropriately modified and improved, for example.

For example, the power system 1 may adopt a forced lubrication system using an oil pump together with the splashing type lubrication system.

1. A power system comprising:
a rotating body;
a housing which accommodates the rotating body; and
a storage portion which is provided at a bottom of the housing to store a liquid medium, wherein
a part of the rotating body is located in the storage portion, and
a part of a strainer which is attachable to and detachable from the housing from outside protrudes in an area on a downstream side from an uppermost portion of the rotating body in a rotation direction of the rotating body, in an inner surface of the housing.

2. The power system according to claim 1, wherein
a protruding portion of the strainer includes an inflow portion provided on an upper surface thereof and a discharge portion provided on a side surface except a lower surface thereof.

3. The power system according to claim 2, wherein
a guiding portion is provided inside the strainer to guide the liquid medium toward a direction away from the discharge portion under the inflow portion, and
a filter is provided between the inflow portion and the guiding portion.

4. The power system according to claim 1, wherein
the power system is a vehicle power system, and
the rotation direction is a rotation direction of the rotating body when the vehicle moves forward.

5. The power system according to claim 1, wherein
the power system includes:
an electric motor that drives a left wheel and a right wheel of the vehicle;
a transmission that is disposed on power transmission paths between the electric motor and the left wheel and between the electric motor and the right wheel:
a differential gear system that distributes output power shifted by the transmission to the left wheel and the right wheel,
the housing accommodates the electric motor, the transmission, and the differential gear system,
the transmission includes:
a first gear that is mechanically connected to the electric motor;
a second gear that has a rotation axis in common with the first gear and is mechanically connected to a differential gear casing of the differential gear system; and
a pinion gear that meshes with the first gear and the second gear, and
the rotating body is the second gear.
